(19) United States
(12) Patent Application Publication
(10) Pub. No.: US 2012/0120221 A1
(43) Pub. Date: May 17, 2012

(54) Body Fluid Analyzing System and an Imaging Processing Device and Method for Analyzing Body Fluids

(75) Inventors: Xiao Xiao Dong, Shanghai (CN); Zhao Hui Du, Shanghai (CN)

(73) Assignee: SIEMENS AKTIENGESELLSCHAFT, Munchen (DE)

(21) Appl. No.: 13/382,076

(22) PCT Filed: Oct. 19, 2010
(86) PCT No.: PCT/EP10/65672

§ 371 Date: Jan. 3, 2012

(30) Foreign Application Priority Data
Oct. 30, 2009 (CN) 200910206700.5

(51) Int. Cl. H04N 7/18

(52) U.S. Cl. 348/77; 348/E07.085

(57) ABSTRACT

The present invention discloses a body fluid analyzing system, comprising: a central control and processing component for sending a control signal to the source image capturing component; a source image capturing component for capturing a body fluid source image according to said control signal and sending said source image to said central control and processing component. Said central control and processing component is further used for transforming source images to image coefficients and generating the corresponding coefficient matrix. Then the coefficient matrix is inversely transformed to a focus-fused image for output. The present invention further discloses an image processing device and method for analyzing body fluid. The application of the present invention can reduce the probability of object image omission or fuzziness and, to a great extent, increase the identification success rate so that the precision of the entire system is increased.

### FIELD OF THE INVENTION

The present invention relates to the field of body fluid analysis. In particular, it relates to image processing devices and methods, as well as body fluid analysis systems, used in image-based automated microscope body fluid analyzers.

### BACKGROUND OF THE INVENTION

Body fluid analysis, especially microscopic urine sediment analysis, is among the most common testing performed in clinical practice, for these tests can accomplish renal, urinary and reproductive diagnosis and provide critical information concerning overall health status. More than 10 kinds of particles can be found in urine samples. Such particles include: red blood cells, white blood cells, exfoliated matter, bacteria, epithelial cells, and crystals (these particles will be referred to as “objects” below). These particles of different shapes and sizes need to be identified and counted in order to generate spectra that reflect proportions of different types of elements, and these in turn are compared to threshold values or health reference values.

As for urine sediment analysis, the traditional manual microscope procedures are plagued with the following problems: they are labor-intensive and time-consuming; different sediment preparation procedures can result in very different counts; there are differences in the implementation of laboratory standards by different observers, etc.

The purposes of the automated urine sediment microscope analyzer developed at the beginning of this century and made by Ausma Corp. were to replace the manual inspection method and to improve precision and throughput. The Ausma system scans urine samples in the counting cell and uses a digital camera connected to an optical microscope to take pictures of the urine sample. The analysis processor uses the designated software to identify and count objects; each object image is automatically classified according to size, shape, contrast and texture characteristics. The final report displays the results according to type.

FIG. 1 is a lateral view of a counting cell and microscope object-glass with urine sample in the current art. In existing analyzers, the counting cell is a small rectangular cell which is a few millimeters long (x-axis) and wide (y-axis) and at least 100 microns high (z-axis). Various particles with diameters ranging from a few microns to a few tens of microns are distributed within this three-dimensional space. It is assumed that their distribution is static at a specific time (for example, for one minute). There is mature technology for conducting complete scans and imaging in the x-y direction. However, as for the z-axis, the depth of field (DOF) of the object-glass is much less than the height of the counting cell. Thus, it becomes necessary to collect images with objects in different layers perpendicular to the z-axis. Therefore, the capture in the vertical direction of sufficient resolution has become a primary image collection challenge in body fluid analysis. In addition, image collection, which is a key step in assuring system precision, has become the step that is the least standardized and the most time-consuming. It also has the highest throughput requirements (not less than 50 to 100 samples per hour). And the fact that the DOF is insufficient makes it even more difficult to avoid image deterioration. Images with fuzzy or omitted objects have a serious impact on identification precision and count results.

The example of the Ausma AVE736 developed by AVE Science and Technology Industry Co., Ltd. is used below as a concrete explanation of how the imaging capturing module in the Ausma system works.

In the Ausma AVE736, after a urine sample is loaded into the counting cell, the sample is initially scanned and objects searched using a low-power (×10) microscope. A report is generated directly if no target is found, and this report will indicate that the sample meets the clinical standard for a healthy person. If a target is found, the low-power microscope will identify, classify and count the larger objects, such as exfoliated matter and epithelial cells, among the particles, and it will capture and keep one image for every field of view. Then, a high-power (×40) microscope is used for further tracking of the targets found by the low-power microscope. The focal plane is adjusted through mechanical adjustment of the object-glass and the sample stage. Following automatic focusing, one image is kept for each high power field (HPF), as shown in FIG. 2. Then, objects are identified, classified and counted in a manner similar to that employed with the low-power microscope, and all the saved images are joined to form the final result.

The current art improves overall efficiency by switching back and forth between a low-power microscope and a high-power microscope during image collection, and it can perform z-axis scans to a certain degree. However, in the case of objects that have the same x and y positions, but which have different z-axis positions, there is a high probability of omission or image fuzziness. This in turn creates uncertainty about image identification and counting, with the result that subsequent processing will require manual intervention (at a rate greater than 20%).

In addition, when an image target is located in multiple DOFs of a z-axis, the final image will be a compromised result. That is, precision in parts will be sacrificed to ensure the quality of the overall image. Therefore, the problem of how to obtain sharp images throughout an entire three-dimensional space urgently requires a solution.

Furthermore, mechanical adjustment of the object-glass limits object scanning speed or depth. The average throughput of the Ausma system is currently 60 samples per hour. Several parties have made hardware and software-related attempts in the current art to expand the DOF of scanning microscopes. The most widely-applied mechanisms in optical microscope focusing include: mechanical adjustment of the entire object-glass glass or relative movement between the object-glass and the sample. To obtain satisfactory resolutions along the z-axis, many types of mechanical focusing equipment have been developed (for example, the Piezo-Z object-glass grader developed by PI). However, mechanical adjustment is quite unreliable.

### SUMMARY OF THE INVENTION

In view of the above, the main objective of the present invention is to provide a body fluid analyzing system and an image processing device and method for analyzing body fluids.

To achieve the above objective, the technical scheme of the present invention is achieved as follows:

A body fluid analyzing system comprising:

A central control and processing component, for sending a control signal to the source image capturing component;

said source image capturing component, for capturing body fluid source images according to said control signal and sending said source images to said central control and processing component;

said central control and processing component being further used for transforming said source images to image coefficients and generating the corresponding coefficient matrix, then the coefficient matrix being inversely transformed to a focus-fused image for output.

Said source image capturing component is for shooting through a microscope the body fluid source images corresponding to multiple stacked layers in one field of view according to said control signal;

said central control and processing component being used for transforming every source image into an image coefficient and generating a coefficient matrix from the image coefficients corresponding to all the source images in one field of view.

The central control and processing component comprises:

a central control unit, for sending out body fluid source image control signals corresponding to the multiple stacked layers shot in one field of view;

an instantaneous resolution collecting unit, for receiving the body fluid source images, collecting the instantaneous resolutions of the source images, and storing them in the central control unit;

said central control unit being further used for generating a coefficient matrix from the instantaneous resolutions corresponding to all the source images in one field of view and sending the coefficient matrix to an inverse transforming unit;

the inverse transforming unit, for inversely transforming the coefficient matrix into a focus-fused image and storing the image in said central control unit.

Said central controlling unit comprises:

a system controller, for sending out control signals to control the operation of the source image capturing component, the instantaneous resolution collecting unit, and the inverse transforming unit;

memory, for storing image data, said image data comprising: source images, coefficient matrices, and focus-fused images.

Said instantaneous resolution collecting unit comprises:

a sampling circuit, for receiving single source images provided by said source image capturing component;

a wavelet decomposition circuit, for wavelet decomposition of said source images;

a discrete wavelet transforming circuit, for transforming the decomposed images into wavelet coefficients.

Said inverse transforming unit comprises:

a wavelet coefficient comparing circuit, for acquiring from said central control unit coefficient matrices and selecting therefrom the maximum wavelet coefficient in every wavelength scale;

a buffer memory unit, for storing the selected wavelet coefficients;

an inverse discrete wavelet transforming circuit, for executing inverse discrete wavelet transformation, transforming selected wavelet coefficients into focus-fused images.

Said source image capturing component comprises: a microscope with an embedded liquid lens, a liquid lens driver, a shutter, a driving unit, a sensor, and an A/D transformer; wherein:

said liquid lens driver is for changing the focal length of the liquid lens according to said control signal;

said driving unit is for driving, in accordance with said control signal, the depression of said shutter;

said sensor is for transmitting to said A/D transformer the sensing signal obtained after depression of said shutter;

said A/D transformer is for providing the captured body fluid source image to said central control and processing component after the A/D transformation of said sensing signal.

An image processing device for analyzing body fluid comprises:

a central control unit, for sending out body fluid source image control signals corresponding to the multiple stacked layers shot in one field of view;

an instantaneous resolution collecting unit, for receiving the body fluid source images, collecting the instantaneous resolutions of the source images, and storing them in said central control unit;

said central control unit being further used for generating a coefficient matrix from the instantaneous resolutions corresponding to all the source images in one field of view and sending the coefficient matrix to an inverse transforming unit;

said inverse transforming unit, for inverse transformation of the coefficient matrix into a focus-fused image and storing the image in said central control unit.

An image processing method for analyzing body fluid comprises:

A. sending to said source image capturing component body fluid source image control signals corresponding to the multiple stacked layers shot in one field of view;

B. receiving the body fluid source images provided by the source image capturing component, transforming every source image into an image coefficient, and generating a coefficient matrix from the image coefficients corresponding to all the source images in the field of view;

C. inversely transforming the coefficient matrix into a focus-fused image for output.

This method further comprises:

D. sending out a synchronization signal after executing step C and executing step E if all the fields of view have been processed, otherwise executing step A for the next field of view;

E. combining the focus-fused images for all the fields of view into the final image.

Said transformation of every source image into an image coefficient comprises: transforming every source image into wavelet coefficients through discrete wavelet transformation;

said inverse transformation of the coefficient matrix into a focus-fused image comprises:

selecting the maximum wavelet coefficient for every wavelength scale from the coefficient matrix;

inverse discrete wavelet transformation of the selected wavelet coefficients into a focus-fused image.

Said body fluid is urine, blood, cerebrospinal fluid, pleural effusion, ascitic fluid, or semen.

The problem that the present invention overcomes is the following: Object omission and fuzziness resulting from insufficient image resolution in the vertical direction hinders effective identification of the objects and thus lowers the precision of the body fluid analyzing system. As can be seen from the technical scheme described above, the present invention overcomes this problem by providing a system, device and method that combine z-axis focal plane stacking with image fusion. As a result, it enables total DOF coverage after stacking of the entire z-axis, thereby improving system precision and image collection speed. Specifically, the present invention combines ultrafast z-axis stacked multi-focal plane image collection with object-oriented image fusion to solve, under extremely high magnification (generally ×400), problems such as omission or fuzziness of focal point objects caused by the use of optical microscopes with extremely narrow depths of field (DOF), so that imaging can be performed on body fluid samples, such as urine samples, using depths greater than the DOF (30 to 50 times). It is clear that the present invention reduces the probability of omission or fuzziness of image objects and thus, to a great extent, improves the identification success rate and raises the precision of the entire system to a new level. Furthermore, the present invention carries out parallel processing of image collection and focal point fusion and thereby greatly reduces actual processing time.

In addition, the present invention employs liquid lenses that can achieve rapid focusing. The refocusing time of a liquid lens is measured in nanoseconds. Moreover, liquid lenses do not make use of movable components to control focusing. Thus, the inertia of liquid lenses is negligible compared to that of mechanical adjustments. Therefore, the present invention has faster image collection.

### BRIEF DESCRIPTION OF THE DRAWINGS

Embodiments of the present invention are described in detail below with reference to the attached drawings so that persons with ordinary skill in the art may have a clear notion of the present invention's features and strengths, including but not limited to those described above. The drawings:

FIG. 1 is a lateral view of a counting cell and microscope object-glass with urine sample in the current art.

FIG. 2 is a diagram of the capture of an image following automatic focusing of every field of vision in the current art.

FIG. 3(a) is a component diagram of an image-based body-fluid analyzing system in an embodiment of the present invention.

FIG. 3(b) is an enlarged diagram of the object-glass 303 in an embodiment of the present invention.

FIG. 4 is a functional diagram of a body fluid analyzing system in an embodiment of the present invention.

FIG. 5 is a component diagram of a component 401 that realizes the central control function in the body fluid analyzing system of an embodiment of the present invention.

FIG. 6 is an operating flow diagram along the time axis of the component 401 in an embodiment of the present invention.

FIG. 7 is a component diagram of a component 402 that realizes the source image capturing function in a body fluid analyzing system of an embodiment of the present invention.

FIG. 8 is a component diagram of a component 403 that realizes the source image instantaneous resolution collecting function in a body fluid analyzing system of an embodiment of the present invention.

FIG. 9 is a component diagram of a component 404 that realizes the inverse transformation function in a body fluid analyzing system of an embodiment of the present invention.

FIG. 10 is a flow diagram of DWT-based image fusion.

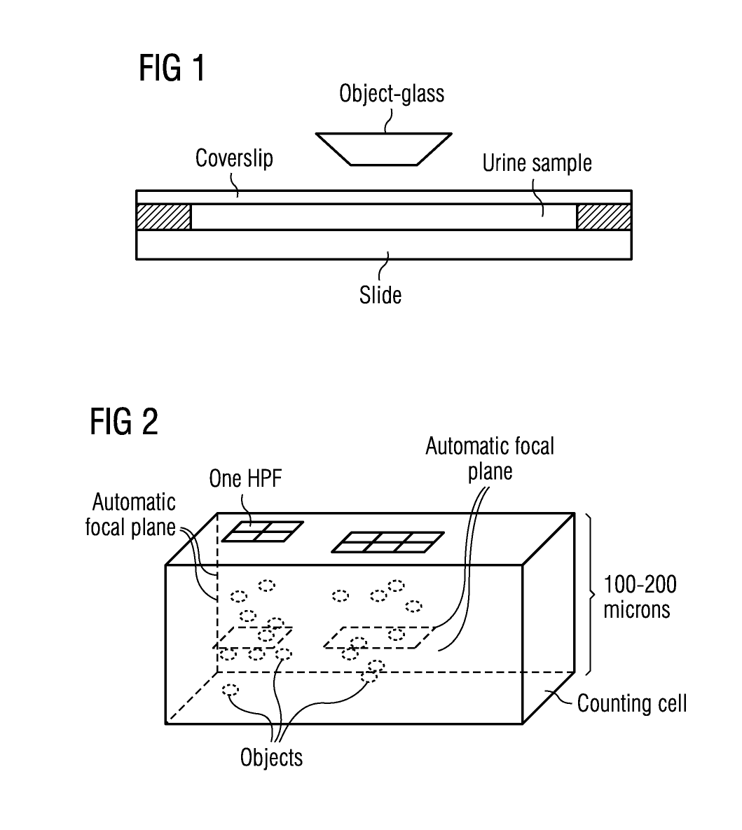

### EXEMPLARY EMBODIMENTS

To make the objectives, technical schemes and strengths of the present invention clearer and easier to understand, the present invention is described in greater detail through the embodiments presented below with reference to the drawings.

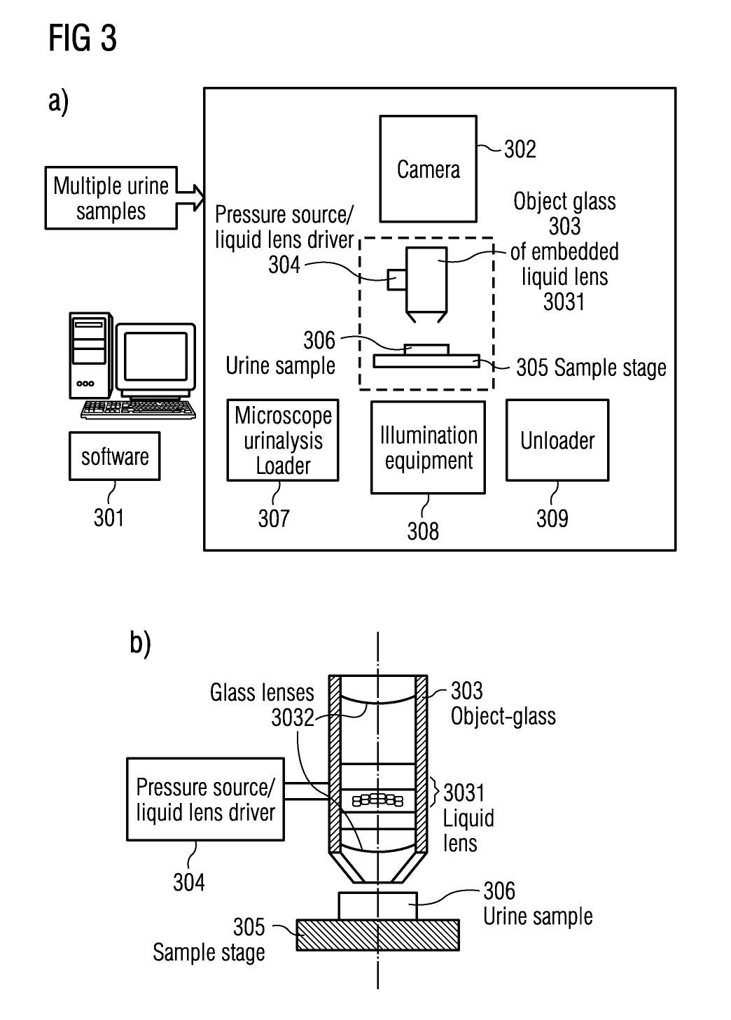

FIG. 3(a) is a component diagram of an image-based body-fluid analyzing system in an embodiment of the present invention. The operating principles of this body fluid analyzing system are described using urine as the sole example. Of course, this system can also be used to analyze other body fluids such as blood, cerebrospinal fluid, pleural effusion, ascitic fluid and semen.

In the system shown in FIG. 3(a), the microscope urinalysis software 301 is for analyzing and processing the images shot with the camera 302. The object-glass 303 of the embedded liquid lens 3031 is connected to the camera 302. This object-glass 303 further comprises zoom lenses 3032. The pressure source/liquid lens driver 304 is for adjusting the liquid lens 3031 to the desired focal length. The urine sample 306 is automatically loaded by the loader 307 onto the sample stage 305 and this puts the urine sample 306 in the field of view of the object-glass 303 of the liquid lens 3031. It is unloaded by the unloader 309. In addition, the illumination equipment 308 is for illuminating the urine sample 306 placed on the sample stage 305.

FIG. 3(b) is an enlarged diagram of the object-glass 303 in an embodiment of the present invention. As can be seen, the liquid lens 3031 which is responsible for focusing is embedded within the lenses 3032 that consist of multiple pieces of glass and that are used for enlargement. The liquid lens 3031 shown in FIG. 3(b) was developed by Carlos A. Lopez and Amir H. Hirsa at the Rensselaer Polytechnic Institute. This liquid lens uses a cylindrical hole to couple two liquid droplets. The opposing curvature of the droplets generates a force similar to elastic force, causing the entire liquid lens system to become a natural oscillator. Within the parameter range of focal lengths from 1 to N, this system can generate resonance, with the result that the droplet shape becomes basically spherical. Thus, it is suitable for z-axis stacked focal plane imaging.

It needs to be explained here that the liquid lens is considered to be a zoom lens with an “infinitely variable” focal length. The surface contours of the droplets are used to determine the focal length of the liquid lens system and ultimately to determine how the liquid lens focuses light. In other words, by changing the surface contours of the droplets, one can adjust the focal length without having to use any moving parts. It can capture any image surface within a given range, and it can precisely make the adjustment from one focal length to another within milliseconds. In recent years, the optical photography systems of embedded liquid lenses have been used in automatic-focus cameras, but liquid lenses have yet to be applied to microscope systems in the current art.

The present invention embeds a liquid lens in a microscope. In this way, it can conveniently capture and keep N images in a series of z-axis focal planes during image collection and is not limited to capturing a single image in every automatic-focus image plane in every field of view (FOV). It thereby establishes a high-efficiency microscope focus adjustment mechanism. N is an integer, and its value equals the value after dividing the height of the counting cell by the DOF thickness. This value can ensure clear focusing on the objects. In other words, for M FOVs, M×N images will be collected and kept.

After z-axis stacked image collection is performed for each field of view, N source images captured using different focal lengths along the z-axis are fused into one and thereupon one focus-fused image is obtained for every field of view. This image includes clear images of all the objects in the field of view. That is, this image has a greater DOF than any source image. It needs to be pointed out that various kinds of image fusion algorithms, such as spatial domain fusion and transform domain fusion, have undergone considerable development. The purpose of these algorithms is to improve the ultimate image so that it has fewer artifacts and higher contrast. Subsequent object identification, classification and counting operations can be completed using common software applications. Lastly, all FOV images are combined to form a final image. What needs to be explained here is that, depending on specific requirements or application scenarios, different kinds of pre-processing and post-processing may be employed for different focus-fusion algorithms. There is no need to say more on that topic here.

I should explain here that, when a high-power magnifying lens is used, one field of view (FOV) can be divided into several high-power fields (HPF) for carrying out image capture, as shown in FIG. 2. Of course, before using a high-power magnifying lens, one can use a low-power magnifying lens for pre-processing, as for example preliminary scans and inspections of objects to determine whether further division in FOVs is necessary.

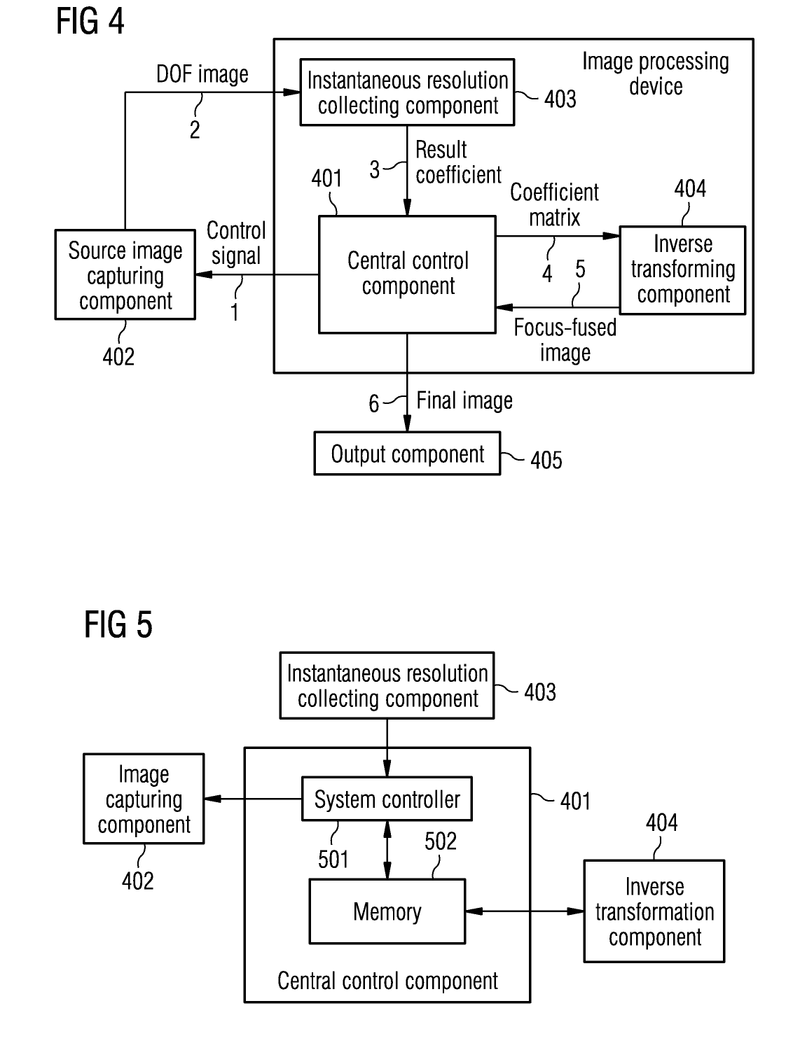

FIG. 4 is a functional diagram of a liquid analysis system in an embodiment of the present invention. This system includes the following functional components: central control component 401, image capturing component 402, instantaneous resolution collecting component 403, reverse transformation component 404, output component 405.

The central control component 401 is for executing system process control, triggering, synchronization, data storage and other such operations. Specifically, the central control component 401 issues a control signal 1 that triggers the image capturing component 402, causing it to take one photograph for one DOF. The designated focal length set can be input by the user or generated self-adaptively by each DOF image collection terminal. In the case of the self-adaptive approach, the next focal length can be estimated based on the focus quality of the most recent image.

The image capturing component 402 is for capturing a single DOF image 2 and transmitting it to the instantaneous resolution collecting component 403 so as to obtain the instantaneous resolution of this image. The instantaneous resolution collecting component 403 is used to send the result coefficient 3 to the central control component 401 for storage so that the result coefficient 3 may be subsequently accessed. Interactions among the components 401, 402, 403 and 401 occur N times until the central control component 401 has output a coefficient matrix 4, wherein N is the number of focal planes stacked on the z-axis.

The inverse transformation component 404 is for inversely transforming the coefficient matrix 4 back to a focus-fused image 5 and transmitting it back to the central control component 401 for storage.

Furthermore, the central control component 401 is for sending the final image 6 to the output component 405 to serve as the final output image.

FIG. 5 is a component diagram of a component 401 that realizes the central control function in the body fluid analyzing system of an embodiment of the present invention. This component 401 comprises: a system controller 501 and memory 502.

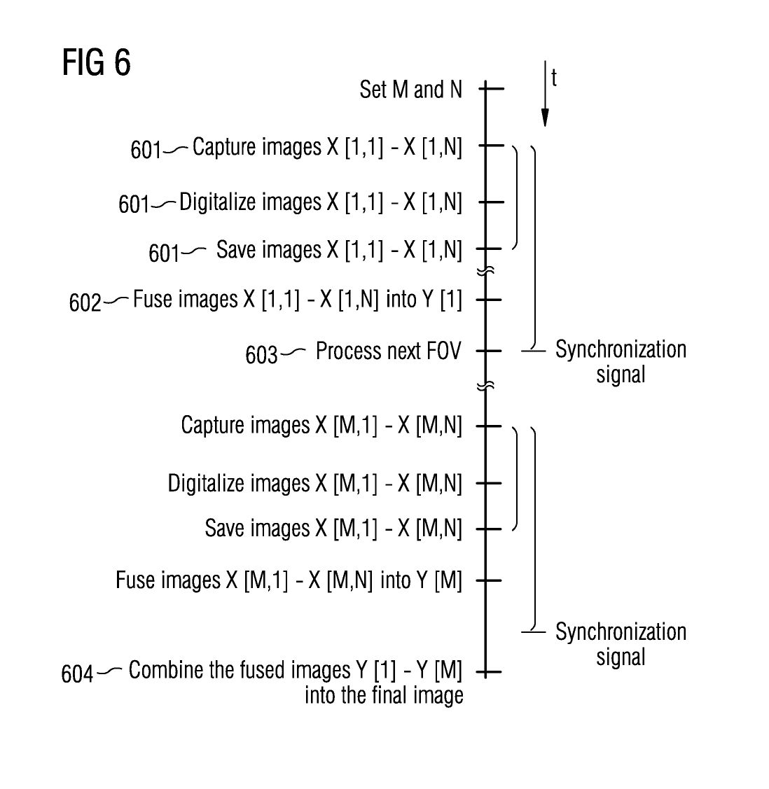

The system controller 501 is for controlling, in accordance with the time series shown in FIG. 6, the image collection process.

The memory 502 is for storing image data. Said image data comprises: source images, wavelet coefficient matrices, focus-fused images, and output images.

FIG. 6 is an operating flow diagram along the time axis of the component 401 in an embodiment of the present invention, wherein M is assumed to be the number of FOVs and N is the number of stacked layers.

Step 601: Control signals are sent out for the m^{th} FOV requesting capture of images X[m, 1] to X[m, N], digitalization of images X[m, 1] to X[m, N], and preservation of the digitalized images X[m, 1] to X[m, N]. The range of the values of m is 1 . . . M.

I should explain here that, in this step, the N images may be processed in a manner similar to parallel processing. For example, while digitalizing image X[m, 1], the system can be simultaneously capturing image X[m, 2]. That is, the capture of image X[m, 2] can be activated without having to wait for X[m, 1] to be stored.

Step 602: A control signal is sent out: fuse X[m, 1] to X[m, n] into Y[m], where X is the source images and Y is the focus-fused image.

Step 603: A synchronization signal is sent out: return to Step 601 to control the next FOV image collection and fusion, and enter Step 604 after all FOV image collections and fusions have been completed.

Step 604: A control signal is sent out: combine Y[1] to Y[M] into a final image.

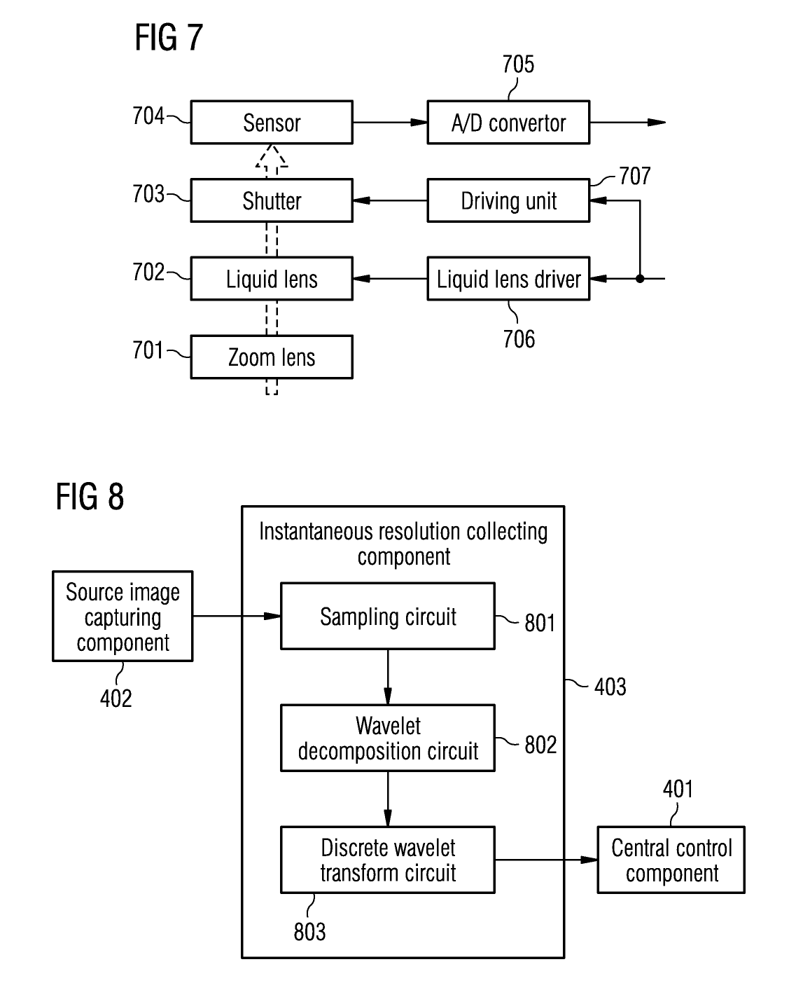

FIG. 7 is a component diagram of a component 402 that realizes the source image capturing function in a body fluid analyzing system of an embodiment of the present invention. This component 402 comprises: a zoom lens 701, a liquid lens 702, a shutter 703, a sensor 704, an A/D transformer 705, a liquid lens driver 706, and a driving unit 707. In this component, light (indicated by the dashed lines in FIG. 7) passes in succession through the zoom lens 701, the liquid lens 702 and the shutter 703 and then arrives at the sensor 704. The sensor 704 functions as an imaging element and performs the duty of conveying sensing signals to the A/D transformer 705. When implementing a specific component, one can use a CCD or CMOS sensor.

FIG. 8 is a component diagram of a component 403 that realizes the source image instantaneous resolution collecting function in a body fluid analyzing system of an embodiment of the present invention. This component 403 comprises: a sampling circuit 801, a wavelet decomposition circuit 802 and a discrete wavelet transform (DWT) circuit 803.

The sampling circuit 801 is for receiving single DOF images provided by the component 402 and for performing digitalized sampling of these images. Specifically, the DOF images can be provided by the A/D convertor 705 in the component 402.

The wavelet decomposition circuit 802 is for performing wavelet decomposition of the images.

The discrete wavelet transform circuit 803 is for transforming the decomposed images into wavelet coefficients.

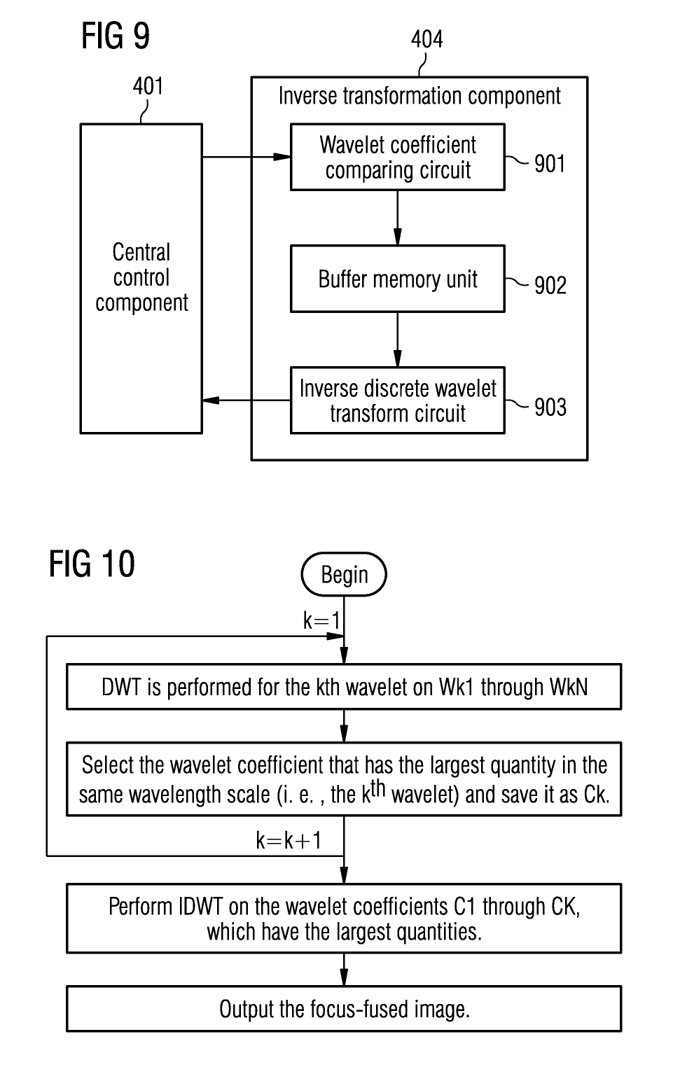

FIG. 9 is a component diagram of a component 404 that realizes the inverse transformation function in a body fluid analyzing system of an embodiment of the present invention. This component 404 comprises: a wavelet coefficient comparing circuit 901, a buffer memory unit 902, and an inverse discrete wavelet transform (IDWT) circuit 903.

The wavelet coefficient comparing circuit 901 is for receiving coefficient matrices and selecting the largest wavelet coefficient in every wavelength scale. The buffer memory unit 902 is for storing the selected wavelet coefficients. The IDWT circuit 903 is for executing inverse discrete wavelet transformation, transforming the selected wavelet coefficients into focus-fused images.

Specifically, assuming that the stacked layers 1 through N consist of K wavelets and the wavelets are numbered W11 through WKN, then the DWT-based image fusion process executed by component 403 and component 404 is as shown in FIG. 10.

Step 1001: DWT is performed for the kth wavelet on Wk1 through WkN, wherein the range of the values of k is 1 . . . K.

Step 1002: Select the wavelet coefficient that has the largest quantity in the same wavelength scale (i.e., the kth wavelet) and save it as Ck. Return to step 1001. After processing of all K wavelets has ended, execute step 1003.

Step 1003: Perform IDWT on the wavelet coefficients C1 through CK, which have the largest quantities.

Step 1004: Output the focus-fused image.

Furthermore, the embodiment of the present invention provides an image processing device for analyzing body fluids. This device is primarily used to control image collection and for processing collected images. Specifically, this image processing device comprises:

A central control unit for sending out body fluid source image control signals corresponding to the multiple stacked layers shot in one field of view; a source image is shot for every stacked layer.

An instantaneous resolution collecting unit for receiving body fluid source images, collecting the instantaneous resolutions of these source images, and storing them in said central control unit. What needs to be explained here is that the instantaneous resolution may be regarded as a type of image coefficient of this image.

Said central control unit is further used for generating a coefficient matrix from the instantaneous resolutions corresponding to all the source images in one field of view and sending the coefficient matrix to an inverse transforming unit.

Said inverse transforming unit is for inversely transforming said coefficient matrix into a focus-fused image and storing the image in said central control unit.

Furthermore, an embodiment of the present invention provides an image processing method for analyzing body fluid, comprising the steps below:

A. sending to said source image capturing component body fluid source image control signals corresponding to the multiple stacked layers shot in one field of view;

B. receiving the body fluid source images provided by the source image capturing component, transforming every source image into an image coefficient, and generating a coefficient matrix from the image coefficients corresponding to all the source images in the field of view;

C. inversely transforming the coefficient matrix into a focus-fused image for output.

This method further comprises:

D. sending out a synchronization signal after executing step C and executing step E if all the fields of view have been processed, otherwise executing step A for the next field of view;

E. combining the focus-fused images for all the fields of view into the final image.

Specifically, the transformation of every source image into an image coefficient comprises: transforming every source image into a wavelet coefficient by means of discrete wavelet transform.

Said inverse transformation of the coefficient matrix into a focus-fused image comprises: selecting the maximum wavelet coefficient for every wavelength scale from the coefficient matrix; inverse discrete wavelet transformation of the selected wavelet coefficient into a focus-fused image.

From the embodiments, it is clear that:

1. The present invention provides a high-precision, high-speed, fully-automated body fluid analysis system that lowers the probability of loss or fuzziness of image objects in the imaging module and thus increases the precision of analysis and identification. Moreover, the present invention can provide high-quality images that can be used as clinical practice documents and references.

2. The object-glass with liquid lens of the present invention has a simple structure and is easy to operate. It does not need to be activated by high voltage or in other special ways. Thus, this design is practicable. Mechanical adjustment of the lens focal length is replaced by electronic timing control. The result is convenience and high speed.

3. The present invention is widely applicable. It is not only applicable to the analysis of urine, but can also easily be expanded to the analysis of other body fluids such as blood, cerebrospinal fluid, pleural effusion, ascitic fluid, semen and other solutions and suspensions.

The above are merely preferred embodiments of the present invention and are not meant to limit the protective scope of the present invention. Any modification, equivalent substitution, or improvement that is done in accordance with the spirit and principles of the present invention shall be included within the protective scope of the present invention.

1. A body fluid analyzing system, comprising:
a central control and processing component, for sending a control signal to the source image capturing component;
said source image capturing component, for capturing body fluid source images according to said control signal and sending said source images to said central control and processing component;
said central control and processing component being further used for transforming said source images to image coefficients and generating the corresponding coefficient matrix, then the coefficient matrix being inversely transformed to a focus-fused image for output.

2. The system as described in claim 1, wherein said source image capturing component is for shooting through a microscope the body fluid source images corresponding to multiple stacked layers in one field of view according to said control signal;
said central control and processing component being used for transforming every source image into an image coefficient and generating a coefficient matrix from the image coefficients corresponding to all the source images in one field of view.

3. The system as described in claim 1, wherein said central control and processing component comprises:
a central control unit, for sending out body fluid source image control signals corresponding to the multiple stacked layers shot in one field of view;
an instantaneous resolution collecting unit, for receiving the body fluid source images, collecting the instantaneous resolutions of the source images, and storing them in the central control unit;
said central control unit being further used for generating a coefficient matrix from the instantaneous resolutions corresponding to all the source images in one field of view and sending the coefficient matrix to an inverse transforming unit;
the inverse transforming unit, for inversely transforming said coefficient matrix into a focus-fused image and storing the image in said central control unit.

4. The system as described in claim 3, wherein said central controlling unit comprises:
a system controller, for sending out control signals to control the operation of the source image capturing component, the instantaneous resolution collecting unit, and the inverse transforming unit;
memory, for storing image data, said image data comprising:
source images, coefficient matrices, and focus-fused images.

5. The system as described in claim 3, wherein said instantaneous resolution collecting unit comprises:
a sampling circuit, for receiving single source images provided by said source image capturing component;
a wavelet decomposition circuit, for wavelet decomposition of said source images;
a discrete wavelet transforming circuit, for transforming the decomposed images into wavelet coefficients.

6. The system as described in claim 3, wherein said inverse transforming unit comprises:
a wavelet coefficient comparing circuit, for acquiring from said central control unit coefficient matrices and selecting therefrom the maximum wavelet coefficient in every wavelength scale;
a buffer memory unit, for storing the selected wavelet coefficients;
an inverse discrete wavelet transforming circuit, for executing inverse discrete wavelet transformation,
transforming selected wavelet coefficients into focus-fused images.

7. The system as described in claim 1, wherein said source image capturing component comprises: a microscope with embedded liquid lens, a liquid lens driver, a shutter, a driving unit, a sensor, and an A/D transformer; wherein:
said liquid lens driver is for changing the focal length of the liquid lens according to said control signal;
said driving unit is for driving, in accordance with said control signal, the depression of said shutter;
said sensor is for transmitting to said A/D transformer the sensing signal obtained after depression of said shutter;
said A/D transformer is for providing the captured body fluid source image to said central control and processing component after the A/D transformation of said sensing signal.

8. An image processing device for analyzing body fluid, wherein it comprises:
a central control unit, for sending out body fluid source image control signals corresponding to the multiple stacked layers shot in one field of view;
an instantaneous resolution collecting unit, for receiving the body fluid source images, collecting the instantaneous resolutions of the source images, and storing them in said central control unit;
said central control unit being further used for generating a coefficient matrix from the instantaneous resolutions corresponding to all the source images in one field of view and sending the coefficient matrix to an inverse transforming unit;
said inverse transforming unit, for inverse transformation of the coefficient matrix into a focus-fused image and storing the image in said central control unit.

9. An image processing method for analyzing body fluid, comprising the steps of:
A. sending to said source image capturing component body fluid source image control signals corresponding to the multiple stacked layers shot in one field of view;
B. receiving the body fluid source images provided by the source image capturing component, transforming every source image into an image coefficient, and generating a coefficient matrix from the image coefficients corresponding to all the source images in the field of view;
C. inversely transforming the coefficient matrix into a focus-fused image for output.

10. The method as described in claim 9, comprising the steps of:
D. sending out a synchronization signal after executing step C and executing step E if all the fields of view have been processed, otherwise executing step A for the next field of view;
E. combining the focus-fused images for all the fields of view into the final image.

11. The method as described in claim 9, wherein said transformation of every source image into an image coefficient comprises: transforming every source image into wavelet coefficients through discrete wavelet transformation;
said inverse transformation of the coefficient matrix into a focus-fused image comprises:
selecting the maximum wavelet coefficient for every wavelength scale from the coefficient matrix;
inverse discrete wavelet transformation of the selected wavelet coefficient into a focus-fused image.

12. The method as described in any claim 9, wherein said body fluid is urine, blood, cerebrospinal fluid, pleural effusion, ascitic fluid, or semen.
